(19) United States
(12) Patent Application Publication
(10) Pub. No.: US 2007/0193078 A1
(43) Pub. Date: Aug. 23, 2007

(54) PROMOTIONAL CALENDAR AND METHOD

(76) Inventor: Paul C. Zimmer, Ferndale, MI (US)

Correspondence Address: JOHN R. BENEFIEL, 280 DAINES ST., #100 B, BIRMINGHAM, MI, 48009, US

(21) Appl. No.: 11/623,249

(22) Filed: Jan. 15, 2007

Related U.S. Application Data
(63) Continuation of application No. 11/388,178, filed on Mar. 23, 2006, now abandoned.
Application No. 11/388,178 is a continuation of application No. 09/612,821, filed on Jul. 10, 2000.
(60) Provisional application No. 60/142,754, filed on Jul. 8, 1999.

(51) Int. Cl. G09D 3/04

(52) U.S. Cl. 40/119

(57) ABSTRACT

A daily calendar used to promote an enterprise to an individual has the name of the individual prominently printed on each page together with an identifier of the enterprise. A text message relating to the enterprise may also appear on each page. The calendar is given to the person with whom the enterprise intends to promote itself.

### CROSS REFERENCE TO RELATED APPLICATIONS

This application is a continuation of U.S. application Ser. No. 09/612,821, filed on Jul. 10, 2000, which claims the benefit of provisional application Ser. No. 60/142,754, filed on Jul. 8, 1999.

### BACKGROUND OF THE INVENTION

This invention concerns business promotion and advertising. Businesses and other enterprises have long used the promotional technique of giving away to customers or other items used everyday which bear the enterprise name and other advertising text.

A prime example of such items are calendars having advertising copy printed on a panel above the monthly calendar pages which are turned or torn off at the beginning of each month.

Since the recipients look at the calendar each day, they are constantly exposed to the enterprise name and advertising copy.

The proven effectiveness of this technique is attested by its long standing practice.

It is the object of the present invention to improve on this technique and the calendar format used to practice this promotional method.

### SUMMARY OF THE INVENTION

The above object and others which will be appreciated by a reading of the following specification and claims is achieved by the distribution of a personalized daily calendar, preferably a perpetual calendar, in which each calendar page is prominently imprinted with the name of the recipient, and the name of the enterprise to be promoted. An informational message which may be related to the enterprise may also be printed on each page.

The prominent appearance of the recipients name on every page attracts the attention of the recipient and creates a favorable association with the enterprise identifier also appearing on that page, which favorable effect is reinforced daily. The recipient is constantly impressed with the value set on the relationship by the enterprise.

The secondary message, which changes on successive pages, offers a chance to inform the recipient of the enterprise and its capabilities. Where a neutral secondary message is utilized, this changing message will attract the interest of the recipient every day.

### DESCRIPTION OF THE DRAWINGS

FIG. 1 is a perspective view of a perpetual daily calendar, showing the format of the first page.

FIG. 2 is a perspective view of the calendar shown in FIG. 1, turned to the page of the next day.

FIG. 3 is a perspective view of the calendar shown in FIGS. 1 and 2, turned to the page of a later date illustrating another use of a secondary message.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

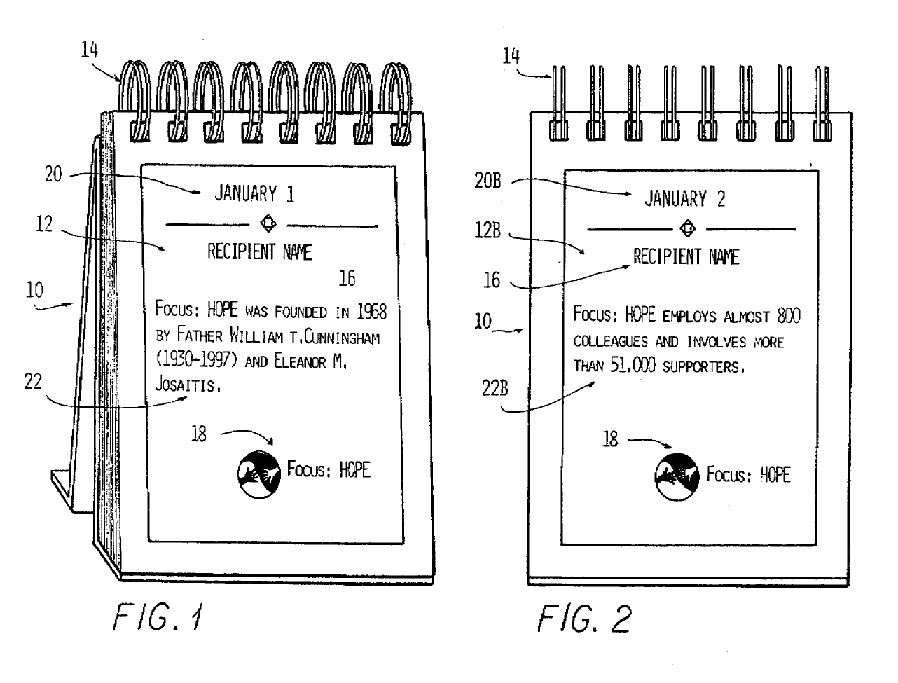

Referring to FIG. 1, a daily calendar 10 is shown, of a type in which each day of the year is imprinted on a separate respective page 12, the pages 12 held together as by a wire ring binding 14. This allows each page 12 to be turned, allowing display of the next day page 12B (FIG. 2). The calendar 10 may be of the “perpetual” type, i.e., the day of the week and holiday notations being omitted to allow multi year use, although this is optional.

Each page 12 has a prominent imprint 16 of the name of an intended recipient, preferably in a central location and in large type just below the date 20 to be conspicuously displayed on each page.

This personalizes the calendar to the recipient. Each page also bears a prominently displayed imprint 18 of the name and/or logo of the enterprise, here Focus Hope, a non profit enterprise operated in Detroit, Mich.

A text message 22 may also be printed on each page, which may be specific to the enterprise, in the example shown concerning the founding of Focus Hope, and are different on each page 12B (22C, FIG. 2).

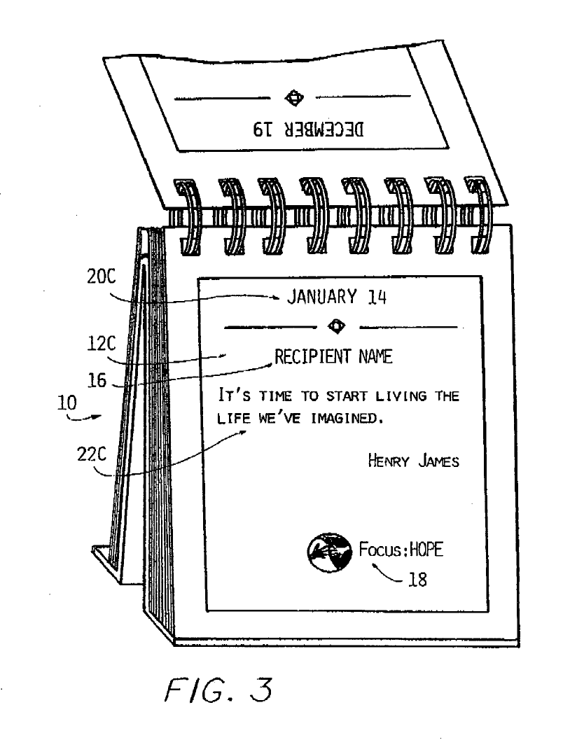

Alternatively, the message 22C (FIG. 3) may be of unrelated content, but attracting the interest of the user.

The personalizing of each page with the imprint of the recipient's name 16 creates an interest and a favorable association with an enterprise whose identifier 18 is likewise prominently imprinted on each page 12.

The secondary message 22 creates interest and opportunity to inform the recipient each day.

A regular calendar, i.e., non perpetual, may alternatively be used.

1. A promotional calendar comprising:
a series of pages each imprinted with a respective day of the year and held together to allow turning or tear off of each page;
each page prominently printed with the name of a person to personalize each page of the calendar;
each page also prominently printed with an identifier of an enterprise to be promoted, unrelated to said person whose name is printed on said page whereby said person's name and said enterprise identifier are visually associated on each page and said enterprise is thereby promoted to said person.

2. The calendar of claim 1 wherein a text message is also imprinted on each calendar page differing from the text messages of the other pages.

3. The calendar of claim 2 wherein only the date is printed on each page to provide a perpetual calendar.

4. A method of promoting an enterprise to selected individuals unrelated to said enterprise comprising the steps of prominently printing the name of each such individual on each page of a daily calendar having a separate page for each day;
imprinting an enterprise identifier on each page of said daily calendar so as to visually associate said printed name and said enterprise identifier on each page thereof, and,
distributing said daily calendar to each of said individuals.

5. The method according to claim 4 further including the step of imprinting a different message relating to the enterprise on each page of said daily calendar.
